(19) United States
(12) Patent Application Publication
(10) Pub. No.: US 2015/0278712 A1
(43) Pub. Date: Oct. 1, 2015

(54) METHOD, APPARATUS, AND PROGRAM

(71) Applicant: FUJITSU LIMITED, Kawasaki-shi (JP)

(72) Inventors: Takushi Fujita, Chigasaki (JP); Eiji Kitagawa, Akashi (JP); Takuro Ikeda, Yokohama (JP)

(21) Appl. No.: 14/511,547

(22) Filed: Oct. 10, 2014

(30) Foreign Application Priority Data
Mar. 27, 2014 (JP) 2014-067061

(51) Int. Cl. G06Q 10/02; G06Q 10/06; G06Q 50/30

(52) U.S. Cl. CPC G06Q 10/02; G06Q 50/30; G06Q 10/06311

(57) ABSTRACT

A method included accepting information on a desired ride place in ride sharing and information on a desired drop-off place in the ride sharing; identifying an amount of change in at least one of travel time and travel distance in case that a past travel path of a candidate vehicle for the ride sharing is changed to a travel path that passes through the desired ride place and the desired drop-off place; and sending a request for the ride sharing to a terminal corresponding to the candidate vehicle in accordance with the identified amount of change.

### CROSS-REFERENCE TO RELATED APPLICATION

This application is based upon and claims the benefit of priority of the prior Japanese Patent Application No. 2014-067061, filed on Mar. 27, 2014, the entire contents of which are incorporated herein by reference.

### FIELD

The embodiments discussed herein are related to a method, an apparatus, and a program.

### BACKGROUND

When, for example, a person is going to travel to a destination, what is done is to ride in a vehicle running along a path close to a path to the destination together. A ride-sharing support technology is also known that finds a ride-sharing partner and establishes ride sharing.

Another technology is also known that implements ride-sharing as desired by a user; the user only submits desired ride-sharing conditions in advance. Another known technology efficiently implements well-planned ride-sharing of a vehicle. Another known technology enables an automobile driver to make contact with at least one person who wants to ride together. Another known technology appropriately supports ride-sharing in various situations in consideration of the current situation of ride sharing wishers who wants ride-sharing and vehicles that accept ride-sharing wishers. Another known technology precisely predicts a destination that is regularly visited with a high probability even if the frequency of visits is low. (For example, see Japanese Laid-open Patent Publication Nos. 2003-44702, 2003-281238, 2012-501024, 2009-289192, and 2010-19631.)

### SUMMARY

According to an aspect of the invention, a method included accepting information on a desired ride place in ride sharing and information on a desired drop-off place in the ride sharing; identifying an amount of change in at least one of travel time and travel distance in case that a past travel path of a candidate vehicle for the ride sharing is changed to a travel path that passes through the desired ride place and the desired drop-off place; and sending a request for the ride sharing to a terminal corresponding to the candidate vehicle in accordance with the identified amount of change.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a ride sharing system in an embodiment;

FIG. 2 is a block diagram illustrating the structure of a ride-sharing requesting apparatus in an embodiment;

FIG. 3 illustrates vehicle travel pattern information in an embodiment;

FIG. 4 illustrates processing, in an embodiment, for creating the vehicle travel pattern information;

FIG. 5 illustrates an operation flow in ride-sharing requesting processing in an embodiment;

FIG. 6 illustrates desired ride-sharing information in an embodiment;

FIG. 7 illustrates vehicle parking state information in an embodiment;

FIG. 8 illustrates an operation flow in ride sharing offering candidate extraction processing in an embodiment;

FIG. 9 illustrates detour costs;

FIG. 10 illustrates probability distributions of departure times and probability distributions of arrival times in arrivals at a desired ride place in ride sharing;

FIG. 11 illustrates results of detour costs, time goodness-of-fit, and ride-sharing goodness-of-fit;

FIG. 12 illustrates ride-sharing wisher information in an embodiment; and

FIG. 13 illustrates the hardware structure of a computer in an embodiment that implements a ride sharing offering candidate terminal, a ride-sharing wisher terminal, and a ride-sharing requesting apparatus.

### DESCRIPTION OF EMBODIMENTS

According to the study by the inventors, the related ride sharing support technology needs to enter offering conditions and uses the current situation about shared vehicles. Entering offering conditions increases the burden on the ride sharing offering person. When the current situation about shared vehicles is used, a ride sharing wisher can efficiently ride at a desired ride place, but after the ride-sharing wisher has rode, it is difficult to increase the entire efficiency until the ride-sharing wisher gets off at a desired drop-off place and the shared vehicle arrives at its destination.

According to embodiments described later, the burden on the ride sharing offering person can be decreased.

Some embodiments of the present disclosure will be described with reference to the drawings. Like elements on a plurality of drawings are denoted by like reference numerals.

When, for example, a person is going to travel to a destination, what is done is to share a vehicle running in a direction close to the destination. In the descriptions below, a person who offers a vehicle used for ride sharing will be referred to as, for example, the ride-sharing offering person, and a candidate who offers a vehicle used for ride sharing will be referred to as, for example, the ride sharing offering candidate. A person who rides in the car of the ride sharing offering candidate will be referred to as the ride sharing wisher.

When, for example, a ride-sharing offering candidate or ride-sharing wisher wants ride sharing in a travel to a destination, it may difficult to find a ride-sharing partner who satisfies the conditions desired by ride-sharing offering candidate or ride-sharing wisher. To assist in solving this problem, the ride-sharing offering candidate and ride-sharing wisher, for example, register ride sharing conditions (place of departure, place of arrival, date and time, etc.) in a server or the like in advance. Then, it can be thought that when the server or another ride-sharing offering candidate or ride-sharing wisher finds a ride-sharing partner who satisfies the conditions, ride sharing is established. In this case, however, each time the ride-sharing offering candidate and ride-sharing wisher want ride sharing, they are asked to enter ride sharing conditions, search for a ride-sharing partner, and performs other complex tasks to establish ride sharing. Therefore, it is preferable to reduce these tasks performed to establish ride sharing.

As another method, it can be thought that a ride sharing offering candidate who satisfies the ride sharing conditions desired by a ride-sharing wisher is found from the route on which the vehicle of the ride sharing offering candidate is running. In this method, however, even if a ride-sharing partner is found, it may be difficult to establish ride sharing because the vehicle is already travelling. Another problem is that there may be no enough time to establish ride sharing. These problems may become factors that impede the establishment of ride sharing. Therefore, when, for example, a ride-sharing wisher wants ride sharing to travel to a destination, a preferable ability is to find a ride-sharing offering candidate, who is a ride-sharing partner, before the ride-sharing offering candidate starts to travel to a destination.

In an embodiment, therefore, previous travel paths travelled by the vehicle of a ride-sharing offering candidate are obtained from the travel history of the vehicle. When, for example, desired conditions including information on a desired ride place and a desired drop-off place in ride sharing are accepted from a ride-sharing wisher, the amounts of changes are obtained in a time to be taken or a distance to be travelled when a previous travel path is changed to a path that passes through the desired ride place and desired drop-off place. According to the obtained amounts of changes, a request to accept ride sharing is sent to a vehicle. Therefore, it is possible to send a request to accept ride sharing in consideration of the amounts of changes from a previous travel route, the amounts of changes being caused as a result of accepting ride sharing. In addition, the ride-sharing offering candidate has no burden to enter conditions for ride sharing that the ride-sharing offering candidate can provide or to search for a ride-sharing partner. It is also possible to appropriately select a ride-sharing offering candidate with which ride sharing is highly likely to be established before, for example, the vehicle of the ride-sharing offering candidate starts to travel.

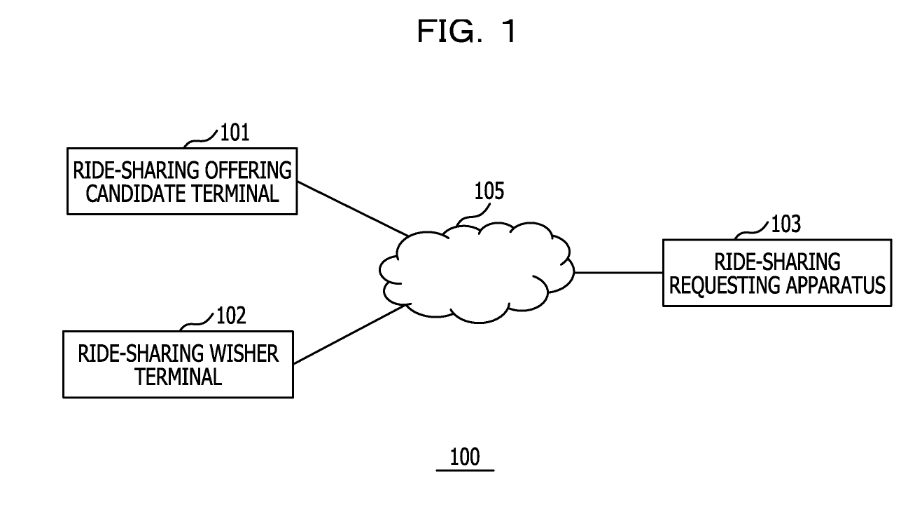

Embodiments will be described below with reference to FIGS. 1 to 12. FIG. 1 illustrates a ride sharing system 100 in an embodiment. The ride sharing system 100 includes, for example, a ride-sharing offering candidate terminal 101, a ride-sharing wisher terminal 102, and a ride-sharing requesting apparatus 103. The ride-sharing offering candidate terminal 101, ride-sharing wisher terminal 102, and ride-sharing requesting apparatus 103 may be mutually coupled through a communication path 105 such as, for example, a wide area network (WAN).

The ride-sharing offering candidate terminal 101 may be, for example, a vehicle-mounted terminal such as a car navigation system mounted in a vehicle offered by the ride-sharing offering candidate for ride sharing or a mobile terminal such as a smartphone, tablet terminal, or mobile telephone terminal of the ride-sharing offering candidate. Alternatively, in another embodiment, a vehicle-mounted terminal and a mobile terminal, for example, may be cooperated to implement the ride-sharing offering candidate terminal 101 with a plurality of devices.

The ride-sharing offering candidate terminal 101 may include, for example, a function that obtains the current position. The current position may be obtained by using, for example, a global positioning system (GPS) receiver, a wireless local area network (LAN) communication device, or another device coupled to the ride-sharing offering candidate terminal 101. The ride-sharing offering candidate terminal 101 may also include a function that detects that the vehicle has been parked and that the vehicle has been started. For example, according to signals that indicate the states of the vehicle, the signals being obtainable from individual parts of the vehicle, and information received from a speed sensor, an acceleration sensor, and the like, the ride-sharing offering candidate terminal 101 may detect that the vehicle has been parked and that the vehicle has been started. The ride-sharing offering candidate terminal 101 may also notify the ride-sharing requesting apparatus 103 of, for example, the current vehicle position, a parked or running state, the current time, and other detected information by using a communication device attached to the ride-sharing offering candidate terminal 101. These information items may be detected and stored, for example, on a periodic basis, and the ride-sharing offering candidate terminal 101 may notify the ride-sharing requesting apparatus 103 of all the stored information at one time. Alternatively, the ride-sharing offering candidate terminal 101 may notify the ride-sharing requesting apparatus 103 of the detected information in real time. In an embodiment, if it is detected that the vehicle has been parked or started, the ride-sharing offering candidate terminal 101 may notify the ride-sharing requesting apparatus 103 of the time of the detection and the place in real time.

The ride-sharing wisher terminal 102 is a terminal used by the ride-sharing wisher. The ride-sharing wisher terminal 102 may be, for example, a mobile terminal, a smartphone, a tablet terminal, a personal computer (PC), a note PC, or another apparatus. Alternatively, the ride-sharing wisher terminal 102 may be a shared public terminal. The ride-sharing wisher terminal 102 may create, for example, desired ride-sharing information 600, which will be described later, from desired ride sharing conditions and other information entered by the ride-sharing wisher and may notify the ride-sharing requesting apparatus 103.

The ride-sharing requesting apparatus 103 may be, for example, a sever or another information processing apparatus. The ride-sharing requesting apparatus 103 may be coupled to, for example, a plurality of terminals including the ride-sharing offering candidate terminal 101 and ride-sharing wisher terminal 102 through the communication path 105. The ride-sharing requesting apparatus 103 may also provide, for example, a ride-sharing requesting service.

From the ride-sharing offering candidate terminal 101, the ride-sharing requesting apparatus 103 may receive, for example, the current position of a vehicle offered for ride sharing, parking state of the vehicle, the time of parking, and other travel history information on a periodic basis or in real time. The ride-sharing requesting apparatus 103 may create, for example, vehicle travel pattern information 300 and vehicle parking state information 700, which will be described below, from the received travel history information. When, for example, the ride-sharing requesting apparatus 103 receives the desired ride-sharing information 600 from the ride-sharing wisher terminal 102, the ride-sharing requesting apparatus 103 may transmit a ride-sharing request to the ride-sharing offering candidate terminal 101.

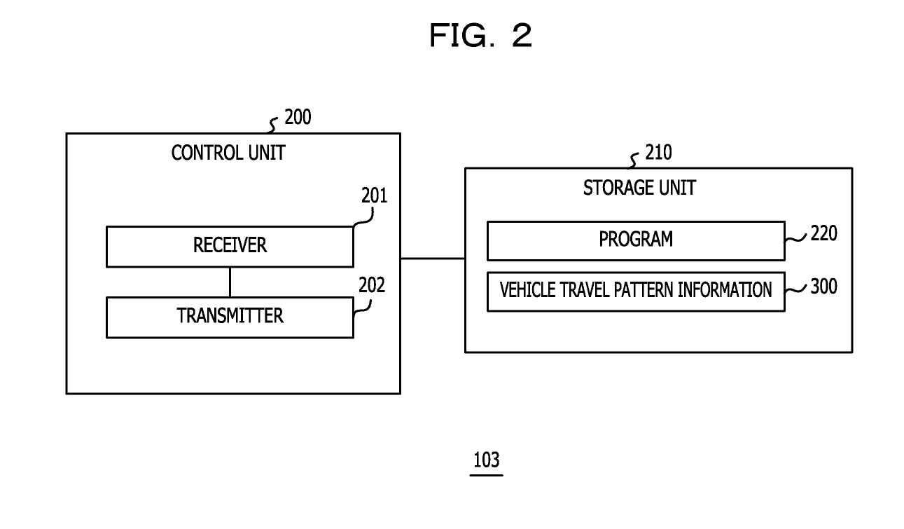

FIG. 2 is a block diagram illustrating the structure of the ride-sharing requesting apparatus 103 in some embodiments. The ride-sharing requesting apparatus 103 includes, for example, a control unit 200 and a storage unit 210. The control unit 200 includes, for example, a receiver 201, a transmitter 202, and other functional units. The storage unit 210 in the ride-sharing requesting apparatus 103 stores, for example, a program 220, the vehicle travel pattern information 300, which will be described later, and other information. The control unit 200 in the ride-sharing requesting apparatus 103 reads out the program 220 and executes it to function as the functional parts of, for example, the receiver 201, the transmitter 202, and the like. These functional parts and information stored in the storage unit 210 will be described later in detail.

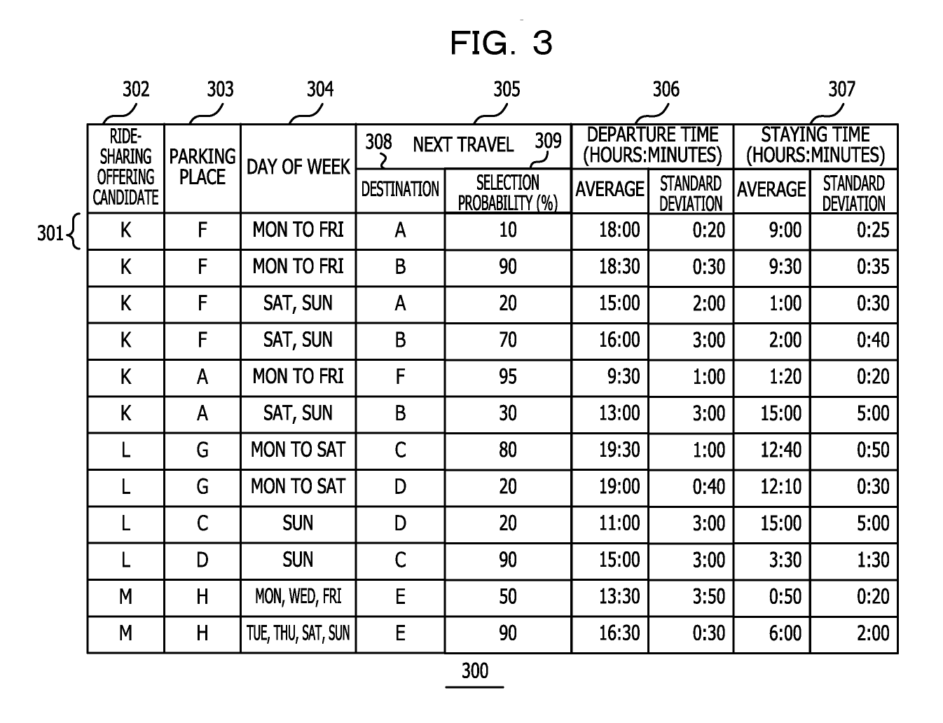

FIG. 3 illustrates the vehicle travel pattern information 300. The vehicle travel pattern information 300 includes, for example, travel patterns 301 created from previous travel paths included in the travel history of the vehicle. Each travel pattern 301 includes, for example, a ride-sharing offering candidate 302, a parking place 303, a day of the week 304, a next travel 305, a departure time (hours: minutes) 306, and a staying time (hours: minutes) 307. These information items are mutually associated by the travel pattern 301.

The ride-sharing offering candidate 302 is, for example, information that identifies the target ride-sharing offering candidate in the information registered in the travel pattern 301. The ride-sharing offering candidate 302 may be, for example, the name of the target ride-sharing offering candidate in the information registered in the travel pattern 301. The parking place 303 may be, for example, a vehicle parking place that is a point from which the vehicle travel registered in the travel pattern 301 starts. In the parking place 303, the address or latitude and longitude of a place where a vehicle is being parked or other information indicating a place, for example, may be registered. The day of the week 304 may be, for example, a day of the week on which the patterned travel registered in the travel pattern 301 is executed. The next travel 305 includes a destination 308 and a selection probability 309. The destination 308 may be, for example, a vehicle parking place at the destination of the vehicle travel registered in the travel pattern 301. For example, in the destination 308, the address or latitude and longitude of a parking place at the vehicle's destination or other information indicating a place may be registered. The selection probability 309 may be the probability (%) that the destination 308 is selected in a travel started from the parking place 303 on the day of the week indicated by the day of the week 304. In the departure time 306, the average and standard deviation of times at which a vehicle starts from the parking place 303 toward the destination 308 in the travel movement registered in the travel pattern 301, for example, are registered. In the staying time 307, the average and standard deviation of staying times during which the vehicle stays at the parking place 303 in the travel movement registered in the travel pattern 301, for example, are registered. That is, for example, the staying time 307 may be the average and standard deviation of times elapsed from a start time at which the vehicle has started to be parked at the parking place 303 in the travel pattern 301 to a departure time at which the vehicle departs toward the destination 308 in the next travel 305.

For example, in the vehicle travel pattern information 300 in FIG. 3, six travel patterns 301 of ride-sharing offering candidate K are registered. From Monday to Friday, for example, K travels from a parking place F toward to A (destination 308) with a selection probability 309 of 10%. In this travel, the average of departure times is 18:00 and their standard deviation is 20 minutes. The average of staying times at the parking place F is 9 hours and their standard deviation is 25 minutes. However, K travels from the parking place F toward to B (destination 308) with a selection probability 309 of 90% from Monday to Friday. In this travel, the average of departure times is 18:30 and their standard deviation is 30 minutes. The average of staying times at the parking place F is 9 hours and 30 minutes and their standard deviation is 35 minutes.

The ride-sharing requesting apparatus 103 may obtain travel history information, which indicates a travel history of a vehicle, from, for example, the ride-sharing offering candidate terminal 101 having a function, such as a GPS receiver, that obtains positional information, the ride-sharing offering candidate terminal 101 being attached to the vehicle of the ride-sharing offering candidate. The ride-sharing requesting apparatus 103 may, for example, extract, as a pattern, a travel path on which a travel is likely to be executed at a high frequency from the previous travel paths included in the travel history of the vehicle by performing statistical processing on the obtained travel history information. The ride-sharing requesting apparatus 103 may create the travel pattern 301 from the extracted pattern of travel and may register the created travel pattern 301 in the vehicle travel pattern information 300.

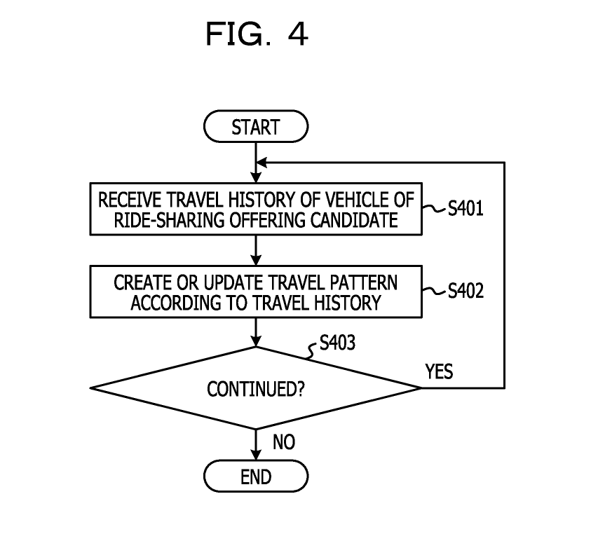

FIG. 4 illustrates processing, in an embodiment, for creating the vehicle travel pattern information 300. The operation flow of processing for creating the vehicle travel pattern information 300 in FIG. 4 is executed when, for example, the control unit 200 in the ride-sharing requesting apparatus 103 reads out and executes the program 220 stored in the storage unit 210. In an embodiment, when the control unit 200 in the ride-sharing requesting apparatus 103 starts to offer a service to request ride sharing, processing for creating the vehicle travel pattern information 300 may be started.

In step 401 (each step described below will be described as S, an example being S401), the control unit 200 in the ride-sharing requesting apparatus 103 receives travel history information including the travel history of the vehicle of the ride-sharing offering candidate 302 eligible for providing a service from, for example, the vehicle. As a history of the travel of the vehicle of the ride-sharing offering candidate 302 over a prescribed period, the travel history information may include, for example, information that associates the position of the vehicle with a time. In S402, the control unit 200 in the ride-sharing requesting apparatus 103 creates or updates the travel pattern 301 according to the travel history of the vehicle, the travel history being included in the received travel history information. For example, the control unit 200 in the ride-sharing requesting apparatus 103 may perform statistical processing on the travel history information obtained from the vehicle of the ride-sharing offering candidate and may create the travel pattern 301 for a travel path on which a travel is likely to be executed at a high frequency. For example, the control unit 200 in the ride-sharing requesting apparatus 103 may organize the previous travels of the vehicle for each pattern, according to the parking place in the vehicle's travel history included in the travel history information. Specifically, for example, travels in which combinations of a certain parking place (that is, place of departure) and a next parking place (that is, destination) are the same and days of the week and departure times are similar may be combined, a vehicle travel pattern may be extracted from the combined travels, and the travel pattern 301 may be created from the extracted pattern. In the example in FIG. 3, previous travel paths included in the travel history are combined according to the common ride-sharing offering candidate, parking place, day of the week, and destination. A selection probability for each destination, the average of departure times and their standard deviation, and the average of staying times and their standard deviation are also calculated. The combined travel path and the above calculated values are registered as the travel pattern 301. Then, the travel path, probability, averages, and standard deviations are registered as the travel pattern 301. If, for example, a previous travel path included in the travel history information is already registered in the vehicle travel pattern information 300 as the travel pattern 301, the control unit 200 in the ride-sharing requesting apparatus 103 may update values of the travel pattern 301 with the travel history information. For example, the control unit 200 in the ride-sharing requesting apparatus 103 obtains, from the travel history information, information on the travel pattern 301 that is already registered in the vehicle travel pattern information 300. Then, the control unit 200 in the ride-sharing requesting apparatus 103 may recalculate information on the obtained already-registered travel pattern 301, the selection probability in the next travel 305, the average and standard deviation in the departure time 306, the average and standard deviation in the staying time 307, and the like, and may update the travel pattern 301 accordingly.

In S403, the control unit 200 in the ride-sharing requesting apparatus 103 decides whether to continue the processing. If the processing is decided to be continued (the decision result in S403 is Yes), the flow returns to S401. If the processing is decided not to be continued (the decision result in S403 is No), this operation flow is terminated. In an embodiment, this decision may be made as to whether the manager of the ride-sharing requesting apparatus 103 has entered, into the ride-sharing requesting apparatus 103, an input signal that stops the processing for creation the vehicle travel pattern information 300. If the manager of the ride-sharing requesting apparatus 103 has entered, into the ride-sharing requesting apparatus 103, an input signal that stops the processing for creating the vehicle travel pattern information 300, the control unit 200 in the ride-sharing requesting apparatus 103 may decide not to continue the processing and may terminate this operation flow.

The vehicle travel pattern information 300 may be created according to, for example, the operation flow described above. Alternatively, the ride-sharing offering candidate identified by the ride-sharing offering candidate 302 in the travel pattern 301, for example, may access the ride-sharing requesting apparatus 103 and may register the travel pattern 301 of the vehicle of the ride-sharing offering candidate to create the vehicle travel pattern information 300.

In the processing in S401 to S403 in the operation flow in FIG. 4, the control unit 200 in the ride-sharing requesting apparatus 103 functions as, for example, as the receiver 201.

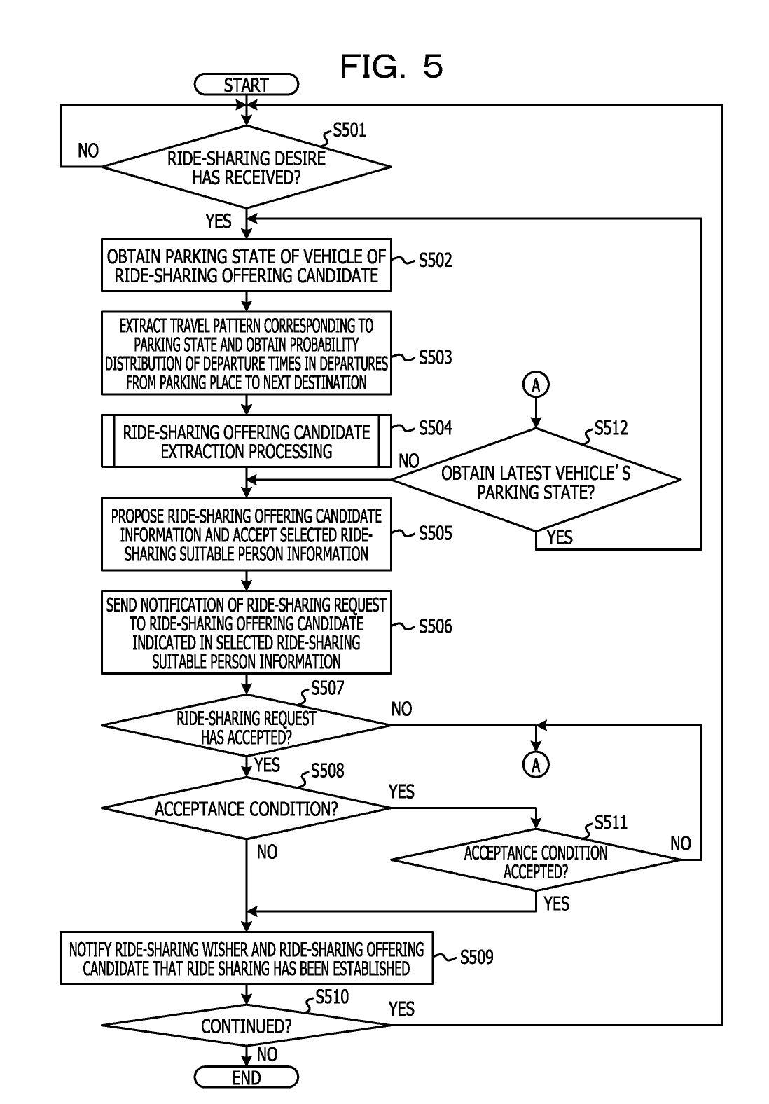

Next, ride-sharing requesting processing in an embodiment will be described with reference to FIGS. 5 to 12. FIG. 5 illustrates an operation flow in ride-sharing requesting processing in an embodiment. The operation flow of ride-sharing requesting processing in FIG. 5 is executed when, for example, the control unit 200 in the ride-sharing requesting apparatus 103 reads out and executes the program 220 stored in the storage unit 210. In an embodiment, when the control unit 200 in the ride-sharing requesting apparatus 103 starts to offer a service to request ride sharing, ride-sharing requesting processing may be started.

In S501, the control unit 200 in the ride-sharing requesting apparatus 103 decides whether a ride-sharing desire has been received.

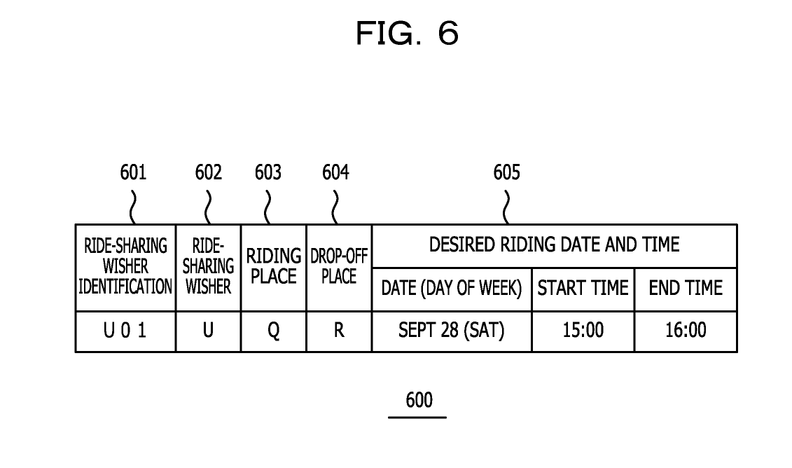

FIG. 6 illustrates the desired ride-sharing information 600 in an embodiment. The desired ride-sharing information 600 is, for example, a notification of a ride-sharing request from the ride-sharing wisher terminal 102. The desired ride-sharing information 600 may include desired ride sharing conditions. For example, the desired ride-sharing information 600 includes a ride-sharing request identification 601, a ride sharing wisher 602, a ride place 603, a drop-off place 604, and a desired riding date and time 605. The ride-sharing request identification 601 may be an identifier assigned to identify the desired ride-sharing information 600 accepted from the ride-sharing wisher. The ride-sharing wisher 602 may be information that identifies the ride-sharing wisher. For example, the ride-sharing wisher 602 may be the name of the ride-sharing wisher. The ride place 603 may be, for example, a ride place (desired ride place) within a section over which the ride-sharing wisher wants ride sharing. The drop-off place 604 may be, for example, a drop-off place (desired drop-off place) within a section over which the ride-sharing wisher wants ride sharing. As the ride place 603 and drop-off place 604, an address, latitude and longitude, or other information that indicates a place, for example, may be registered. The desired riding date and time 605 is information on a desired ride time at which the ride-sharing wisher wants ride sharing. As a date (a day of the week) and a ride time in ride sharing, the desired riding date and time 605 may include, for example, a start time and an end time in a desired time zone or other information on a date and time at which the ride-sharing wisher wants ride sharing. In the example in FIG. 6, in which the ride-sharing wisher identification 601 is U01, a ride-sharing wisher 602 (in this example, U) wants ride sharing from a ride place Q to a drop-off place R at a ride time, at the ride place, from 15:00 to 16:00 on September 28 (Saturday). In S501, the control unit 200 in the ride-sharing requesting apparatus 103 may receive, for example, the desired ride-sharing information 600 as described above as a ride-sharing desire.

If no ride-sharing desire has been received in S501 (the result in S501 is No), the flow returns to S501, repeating the processing. If a ride-sharing desire has been received (the result in S501 is Yes), the flow proceeds to S502. In S502, the control unit 200 in the ride-sharing requesting apparatus 103 obtains the parking state of the vehicle of the ride-sharing offering candidate from the ride-sharing offering candidate terminal 101. The control unit 200 in the ride-sharing requesting apparatus 103 may create, for example, the vehicle parking state information 700 from the obtained parking state of the vehicle of the ride-sharing offering candidate.

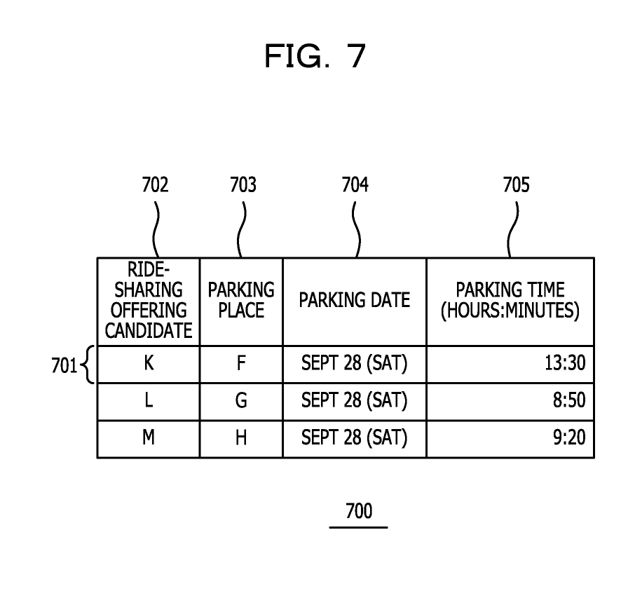

FIG. 7 illustrates the vehicle parking state information 700 in an embodiment. The vehicle parking state information 700 includes, for example, parking information 701, in which information on the parking place of the vehicle of the ride-sharing offering candidate who offers ride sharing is registered. The parking information 701 includes, for example, a ride-sharing offering candidate 702, a parking place 703, a parking date 704, and a parking time 705. The ride-sharing offering candidate 702 may be, for example, information that identifies the target ride-sharing offering candidate in the information registered in the parking information 701. For example, the ride-sharing offering candidate 702 may be the name of the target ride-sharing offering candidate in the information registered in the parking information 701. The parking place 703 may be, for example, the current parking place or the immediately preceding parking place of the vehicle of the target ride-sharing offering candidate in the information registered in the parking information 701. As the parking place 703, the address or the latitude and longitude of the current parking place or immediately preceding parking place of the vehicle of the ride-sharing offering candidate or other information that indicates the place, for example, may be registered. The parking date 704 may be, for example, information on the date on which the vehicle of the target ride-sharing offering candidate in the information registered in the parking information 701 was parked in the current parking place or immediately preceding parking. The parking time 705 may be, for example, information on the parking start time at which the vehicle of the target ride-sharing offering candidate in the information registered in the parking information 701 was parked in the current parking place or immediately preceding parking. In the example in FIG. 7, in which the ride-sharing offering candidate 702 is K, K packed a vehicle at a packing place F at a packing start time of 13:30 on September 28 (Saturday). In S502, the control unit 200 in the ride-sharing requesting apparatus 103 may obtain the current parking place of the vehicle of the ride-sharing offering candidate 702 and a date and time at which parking started through the ride-sharing offering candidate terminal 101 of the ride-sharing offering candidate 702 such as an in-vehicle terminal mounted in the vehicle of the ride-sharing offering candidate 702. Then, the control unit 200 in the ride-sharing requesting apparatus 103 may create, for example, the vehicle parking state information 700 as described above from the obtained information.

In S503, the control unit 200 in the ride-sharing requesting apparatus 103 extracts travel patterns 301 corresponding to the vehicle's parking state obtained in S502 from the vehicle travel pattern information 300. For example, the control unit 200 may extract travel patterns 301 that include the ride-sharing offering candidate 302, parking place 303, day of the week 304, departure time 306, and staying time 307 that correspond to the ride-sharing offering candidate 702, parking place 703, parking date 704, and parking time 705. That is, for example, the control unit 200 may extract travel patterns 301 in which the ride-sharing offering candidate 302 matches the ride-sharing offering candidate 702 in the parking information 701 and the parking place 303 matches the parking place 703. From the extracted travel patterns 301, the control unit 200 may further extract travel patterns 301 in which the day of the week 304 corresponds to the parking date and time in the parking information 701 and a parking date and time inferred from the departure time 306 and staying time 307 substantially matches the parking date and time in the parking information 701. The control unit 200 in the ride-sharing requesting apparatus 103 then obtains a probability distribution of departure times in departures from the current parking place to the destination 308 for the extracted travel patterns 301. Assuming that the probability distribution of departure times indicates a normal distribution, an example will be described below in which a probability distribution P(d, t) of departure times is obtained from the average and standard deviations of departure times and staying times according to Eq. 1 below.

P(d, t)=P_{d}·{f(t, μ_{w}, σ_{w})+f(t−Tp, μₛ, σₛ)}2 (Eq. 1)

The symbols in the above equation have the following meanings.

P(d, t): Probability distribution function related to departure times in departures at time t toward a destination d

P_{d}: Probability that the destination of a next travel is d

f(t, μ, σ): Normal distribution with an average μ and a standard deviation σ

t: Departure time

Tp: Parking start time at the current parking place

μ_{w}: Average of departure times when the destination is d

σ_{w}: Standard deviations of departure times when the destination is d

μₛ: Average of staying times when the destination is d

σₛ: Standard deviations of staying times when the destination is d

P_{d} can be obtained from the selection probability 309 for the destination 308 of the next travel 305 in the travel pattern 301. μ_{w}, and σ_{w} can be respectively obtained from the average and standard deviation in the departure time 306 in travel patterns 301. μₛ, and σₛ can be respectively obtained from the average and standard deviation in the staying time 307 in travel patterns 301. Tp can be obtained from the parking date 704 and parking time 705 in the parking information 701. For all travel patterns 301 extracted in S503, therefore, a probability distribution of departure times in departures from the current parking place to the destination 308 in the next travel 305 can be obtained according to Eq. 1 above. In Eq. 1, t−Tp represents a staying time during which the vehicle is staying at the parking place 303.

The use of Eq. 1 to calculate a probability distribution of departure times is only an example. Another method may be used to obtain a probability distribution of departure times. When, for example, a ride-sharing offering candidate goes to and leaves a company at which working hours are fixed or a similar location, the standard deviation tends to become relatively small. For shopping or the like on holidays, however, departure times in departures from shopping places are various times, but the standard deviation of staying times at shopping places tends to become relatively small. Accordingly, when a probability distribution of departure times is obtained by focusing on the departure time 306 or staying time 307, whichever produces a smaller standard deviation, precision in departure time inference is likely to be improved. Instead of using Eq. 1, therefore, a probability distribution of departure times may be obtained so as to focus on the departure time 306 or staying time 307 in the vehicle travel pattern information 300, whichever produces a smaller standard deviation. For example, if, in the vehicle travel pattern information 300, the standard deviation in the departure time 306 is smaller than the standard deviation in the staying time 307, Eq. 2 below may be used as the probability distribution function related to departure times in departures at time t toward destination d.

P(d, t)=P_{d}·f(t, μ_{w}, σ_{w}) (Eq. 2)

By contrast, if, in the vehicle travel pattern information 300, the standard deviation in the staying time 307 is smaller than the standard deviation in the departure time 306, Eq. 3 below may be used as the probability distribution function related to departure times in departures at time t toward destination d.

P(d, t)=P_{d}·f(t−Tp, μₛ, σₛ) (Eq. 3)

In another embodiment, a probability distribution of departure times may be obtained by using other than a normal distribution. For example, another probability distribution indicating a distribution having a shape similar to the shape of a normal distribution may be used. Alternatively, a triangular distribution, a uniform distribution, and the like may be used. A combination of these probability distributions may also be used. Alternatively, a calculation equation that changes a probability distribution with time may be used; for example, the probability that a departure occurs at a departure time in a previous travel is assumed to be 0 and the probability is saved for the future by a corresponding amount. Alternatively, another embodiment may be implemented so that a probability distribution appropriate for the shape of a distribution of departure times in actual previous travels is selected when the travel pattern 301 is extracted from the travel history of a vehicle.

In the example in FIG. 3, a case is exemplified in which similar travels in previous travel paths included in the travel history of a vehicle are organized and extracted as a pattern of travels of the vehicle and their average and standard deviation are obtained and registered as values that characterize the departure time 306 and staying time 307. However, the embodiment is not limited to this; for example, other values that can be obtained from the travel history of the vehicle may be registered in the departure time 306 and staying time 307 and may be used to infer a departure time. As an example, a representative value (such as, for example, a medium value or a mode value) may be registered in the departure time 306 and staying time 307 and may be used, the representative value being representative of a plurality of departure times or a plurality of staying times in a plurality of travel paths indicating similar travels in previous travel paths included in the travel history of the vehicle.

In S503, the control unit 200 in the ride-sharing requesting apparatus 103 may roughly select, from travel patterns 301 registered in the vehicle travel pattern information 300, candidates that may offer ride sharing according to the desired ride-sharing information 600. If, for example, a distance from the ride place 603 in the desired ride-sharing information 600 to the parking place 303 is too long, travel patterns 301 including the parking place 303 may not be preferable for offering ride sharing. When the control unit 200 in the ride-sharing requesting apparatus 103 extracts a travel pattern 301 corresponding to the parking state in S503, therefore, the control unit 200 may further extract a travel pattern 301 including the parking place 303 at a prescribed distance from the ride place 603 in the desired ride-sharing information 600. If, for example, candidates that may offer ride sharing are roughly selected in this way, a burden on ride sharing processing can be reduced.

Next, in S504, the control unit 200 in the ride-sharing requesting apparatus 103 executes ride-sharing offering candidate extraction processing.

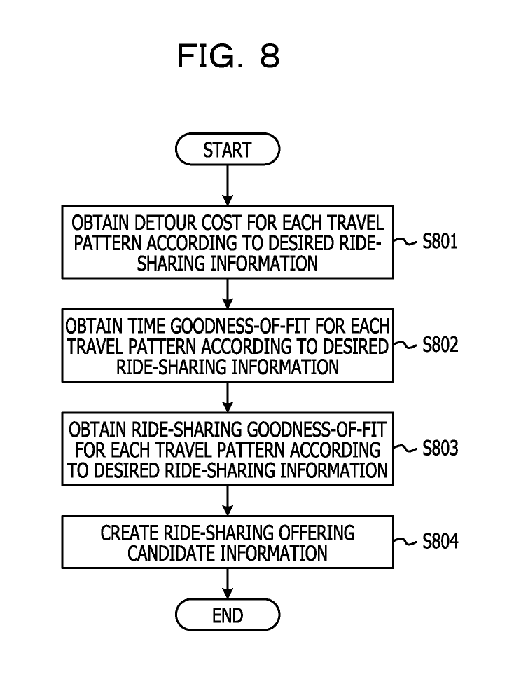

FIG. 8 illustrates an operation flow in ride sharing offering candidate extraction processing in an embodiment. The operation flow of ride-sharing offering candidate extraction processing in FIG. 8 is executed when, for example, the control unit 200 in the ride-sharing requesting apparatus 103 reads out and executes the program 220 stored in the storage unit 210. In an embodiment, when the flow proceeds to S504 in FIG. 5, the ride-sharing offering candidate extraction processing in FIG. 8 starts.

In S801, the control unit 200 in the ride-sharing requesting apparatus 103 obtains a detour cost C(d) for each travel pattern 301 (that is, for each destination of each ride-sharing offering candidate) extracted in S503 according to the desired ride-sharing information 600. The detour cost may represent an increase in fuel cost due to an additional distance travelled to accept ride sharing in the desired ride-sharing information 600, an increase in travelling time, and the like as a cost. Therefore, the detour cost is, for example, a value corresponding to the amount of change in elapsed time or travelled distance that will occur due to a switchover from an original travel path to a travel path that passes through a desired ride place and a desired drop-off place to accept ride sharing.

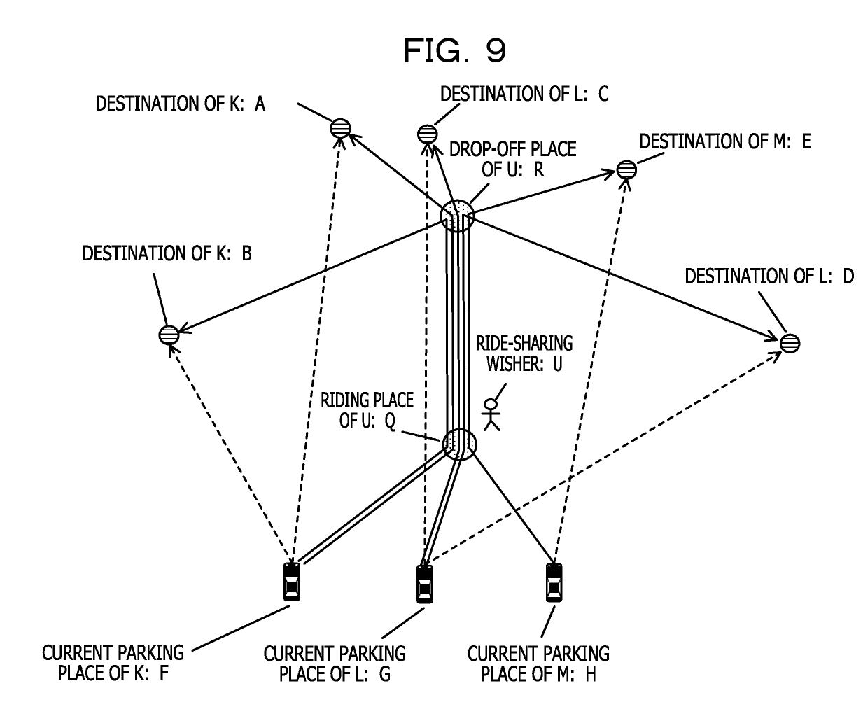

FIG. 9 illustrates detour costs. In FIG. 9, ride-sharing offering candidates K, L, and M and a ride-sharing wisher U are indicated. Ride-sharing offering candidates K, L, and M are assumed to be currently parking their vehicles at parking places F, G, and H, respectively. It is also assumed that, in S503, travel patterns 301 including the destination 308 in the next travel 305 indicated below have been extracted for ride-sharing offering candidates K, L, and M according to the current parking place, the parking start date and time, and the like.

Destination in the next travel of K: A or B

Destination in the next travel of L: C or D

Destination in the next travel of M: E

Ride-sharing wisher U is assumed to want ride sharing from the ride place 603 (in this example, Q) to the drop-off place R (604) in the desired ride-sharing information 600. If ride sharing is not offered in FIG. 9, paths directly toward individual destinations (indicated by the dashed lines in FIG. 9) are obtained. Detour paths (indicated by the solid lines in FIG. 9) are also obtained that ride-sharing offering candidates K, L, and M follow toward their destinations through Q (ride place 603) and drop-off place 604 (in this example, R) in the desired ride-sharing information 600 about ride-sharing wisher U. In FIG. 9, the paths are indicated by straight lines, but in practice, they may be paths searched for according to actually present roads. When a detour path is followed, it is compared with the path directly toward the destination and an additional cost caused by the detour is obtained as the detour cost. The detour cost may be an amount of money calculated from, for example, an increase in fuel cost due to an additional distance travelled for the detour, an increase in travelling time, or the like. As an example, according to the additional distance travelled or additional travelling time caused on the detour path, the detour cost may be calculated by, for example, counting one kilometer of the additional distance travelled due to the detour as 10 yen or counting one minute of the additional travelling time caused by the detour as 10 yen. In the example in FIG. 9, when K travels toward A, L travels toward C, and M travels toward E, the detour costs are relatively low. However, when K travels toward B and L travels toward D, the detour costs are relatively high.

Next, in S802, the control unit 200 in the ride-sharing requesting apparatus 103 obtains time goodness-of-fit for each travel pattern 301 (that is, for each destination of each ride-sharing offering candidate) extracted in S503 according to the desired ride-sharing information 600. A case will be exemplified below in which a probability distribution function related to arrival times in arrivals at the ride place 603 in the desired ride-sharing information 600 is obtained from the probability distribution function related to departure times, which has been obtained by Eq. 1 above, to obtain a time goodness-of-fit.

When the vehicle of a ride-sharing offering candidate detours and arrives at the ride place 603 in the desired ride-sharing information 600 to offer ride sharing, a probability distribution function related to arrival times can be obtained according to, for example, Eq. 4 below.

Pr(d, t)=P(d, t−Tc) (Eq. 4)

The symbols in the above equation have the following meanings.

Pr(d, t): Probability distribution function related to arrival times in arrivals at the ride place in the ride-sharing desire

d: Destination

t: Arrival time at which the vehicle arrives at the ride place in the ride-sharing desire

Tc: Travelling time from the current parking place to the desired ride place in the ride-sharing desire

Therefore, the probability distribution function Pr(d, t) related to arrival times in arrivals at the ride place 603 in the desired ride-sharing information 600 may indicate, for example, a probability distribution obtained by shifting the probability distribution P(d, t) related to departure times by an amount equivalent to a travelling time taken to travel from the current parking place to the ride place in the ride-sharing desire.

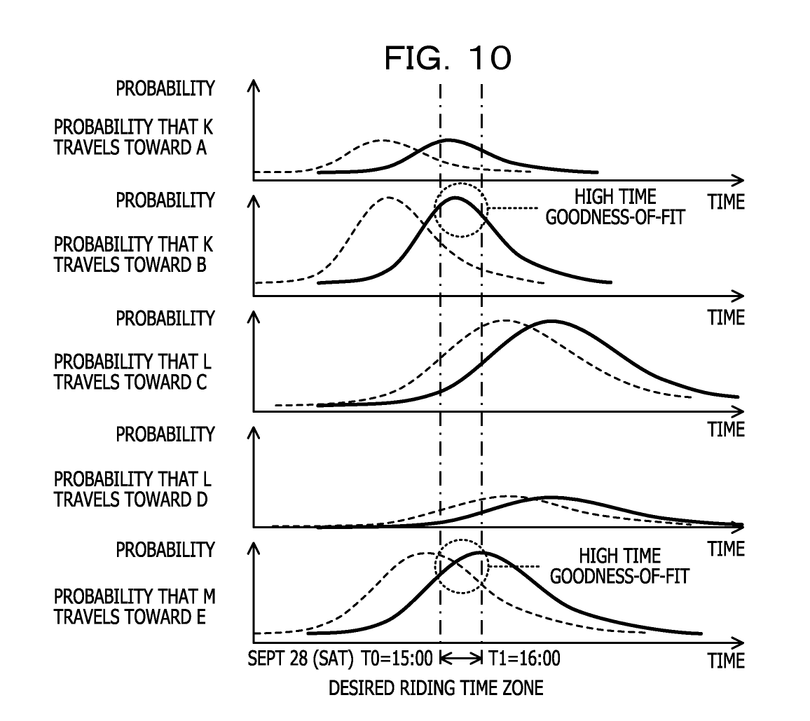

FIG. 10 illustrates the probability distribution function P(d, t) related to departure times and the probability distribution function Pr(d, t) related to arrival times in arrivals at the ride place in the ride-sharing desire. In FIG. 10, the probability distribution function P(d, t) related to departure times is indicated by the dashed-line graphs, and the probability distribution function Pr(d, t) related to arrival times in arrivals at the ride place in the ride-sharing desire are indicated by the solid-line graphs. In the examples in FIG. 10, each probability distribution function takes a value in consideration of the selection probability 309 (Pd) for each destination 308 as indicated by Eq. 1; the higher the probability that the destination is selected is, the higher the entire height of the graph is. Time goodness-of-fit may be obtained so that the value of a travel pattern 301 for which the probability that a vehicle arrives at the ride place 603 within the time zone in the desired riding date and time 605 in the desired ride-sharing information 600 is high becomes high by using the probability distribution function Pr(d, t) related to arrival times in arrivals at the ride place in the ride-sharing desire.

As an example, time goodness-of-fit may be obtained as described below. Time goodness-of-fit may be obtained from, for example, Eq. 5 below by using, for example, the probability distribution function Pr(d, t) related to arrival times in arrivals at the ride place in the ride-sharing desire, which has been obtained according to Eq. 4, and the desired riding date and time 605 in the desired ride-sharing information 600.

$$At ( d ) = {\int }_{t = T 0}^{T 1} Pr ( d , t ) d t \qquad ( Eq . 5 )$$

The symbols in the above equation have the following meanings.

At(d): Time goodness-of-fit to a ride-sharing desire related to the destination d of the ride-sharing offering candidate

T0, T1: Desired riding date and time in a ride-sharing desire (Riding is desired at a time from T0 to T1.)

Here, T0 is, for example, a start time on the date (day of the week) in the desired riding date and time 605, and T1 is, for example, an end time on the date (day of the week) in the desired riding date and time 605. Time goodness-of-fit is, for example, a value indicating a degree to which, when the ride-sharing offering candidate detours to offer ride sharing, a probability distribution of arrival times in arrivals at the ride place in the ride-sharing desire and a desired ride time zone in a ride-sharing desire match as illustrated in FIG. 10. The probability distribution function Pr(d, t) related to arrival times may be obtained from the travelling time from the current parking place 303 to the ride place 603 in the ride-sharing desire and the probability distribution function P(d, t) related to departure times as described above.

As for Eq. 5, an example has been described in which an area in the probability distribution in a zone from T0 to T1 is used. However, the embodiment is not limited to this: for example, an equation that calculates the square of the area in the probability distribution of arrival times in the zone from T0 to T1 as time goodness-of-fit may be used instead of Eq. 5. Time goodness-of-fit may be calculated by an equation that highly evaluates a travel pattern 301 for which the probability that the vehicle can stop at the ride place 603 is high in the time zone in the desired riding date and time 605 in the desired ride-sharing information 600. An example has been described above in which a time zone from the start time to the end time on the date (day of the week) in the desired riding date and time 605 is used as the zone from T0 to T1. In another embodiment, however, a certain time zone, for example, near the start time on the date (day of the week) in the desired riding date and time 605 may be used as the zone from T0 to T1. Accordingly, time goodness-of-fit can be used to identify, out of the previous travel paths indicated in the travel pattern 301, a travel path that is inferred to have a high probability that a vehicle runs on the travel path at the desired ride time or in a time zone including the desired ride time.

Next, in S803, the control unit 200 in the ride-sharing requesting apparatus 103 obtains ride-sharing goodness-of-fit for each travel pattern 301 (that is, for each destination of each ride-sharing offering candidate) extracted in S503 according to the desired ride-sharing information 600. Ride-sharing goodness-of-fit is, for example, a value that can be used as an index indicating whether the travel path indicated in the travel pattern 301 is suitable to the ride-sharing desire in the desired ride-sharing information 600. Ride-sharing goodness-of-fit may be obtained according to, for example, the detour cost obtained in S801 and the time goodness-of-fit obtained in S802. Therefore, ride-sharing goodness-of-fit is, for example, a value corresponding to the amount of change in elapsed time or travelled distance that will occur due to a switchover from an original travel path to a travel path that passes through a desired ride place and a desired drop-off place to accept ride sharing.

In the above example, a higher value of time goodness-of-fit, for example, indicates a travel pattern 301 in which a vehicle will depart at a time more suitable to ride-sharing in the desired ride-sharing information 600. A higher detour cost, for example, indicates a travel pattern 301 that involves a longer additional running distance or a longer additional running time due to a detour for ride sharing indicated in desired ride-sharing information 600, so a low detour cost is suitable for ride sharing. In an embodiment, therefore, ride-sharing goodness-of-fit may be obtained so that, for example, its value becomes high for a travel pattern 301 in which time goodness-of-fit is high and that involves a low detour cost.

As an example, ride-sharing goodness-of-fit may be calculated by using, for example, Eq. 6 below.

Ad(d)=At(d)×(Cb−C(d))/Cb (Eq. 6)

The symbols in the above equation have the following meanings.

Ad(d): Ride-sharing goodness-of-fit related to the destination d of the ride-sharing offering candidate

At(d): Time goodness-of-fit to a ride-sharing desire related to the destination d of the ride-sharing offering candidate

C(d): Detour cost related to the destination d of the ride-sharing offering candidate

Cb: Reference cost for the detour cost, the reference cost being used to adjust the degree of contribution to ride-sharing goodness-of-fit

If a relative large amount of money such as, for example, 10,000 yen is assigned to Cb, the effect of a difference in detour cost on ride-sharing goodness-of-fit Ad(d) is reduced. If, a relative small amount of money such as, for example, 1,000 yen is assigned to Cb, the effect of the detour cost on ride-sharing goodness-of-fit is increased. If, for example, the detour cost exceeds the reference cost Cb, the value of Eq. 6 becomes negative. Therefore, when the reference cost is used, travel patterns 301 that involve a detour cost exceeding the reference cost, for example, can be excluded. In the way described above, for example, ride-sharing goodness-of-fit can be obtained for each travel pattern 301 (that is, for each destination of each ride-sharing offering candidate) extracted in S503 according to the desired ride-sharing information 600.

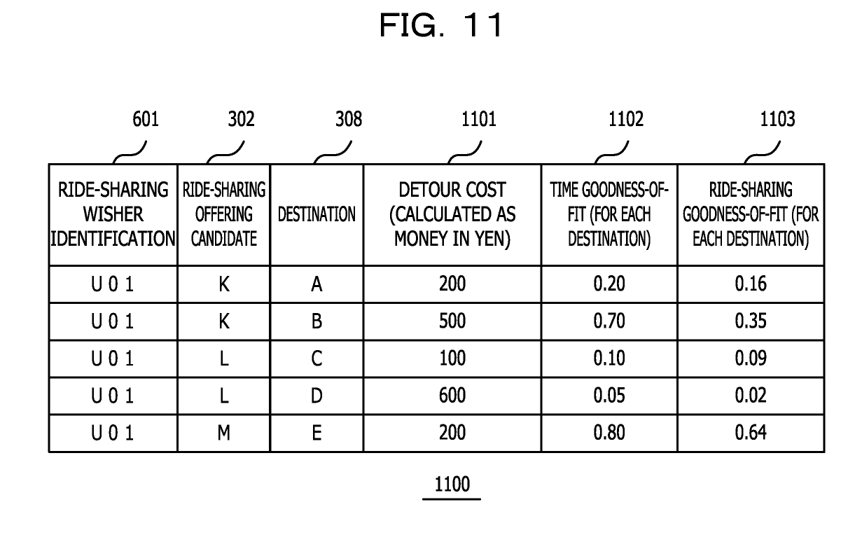

FIG. 11 illustrates, as a list 1100, results of detour costs, time goodness-of-fit, and ride-sharing goodness-of-fit that have been obtained in S801 to S803 above. In FIG. 11, a detour cost 1101, time goodness-of-fit 1102, and ride-sharing goodness-of-fit 1103 are illustrated for each travel pattern 301 extracted in S503 for the ride-sharing wisher identification 601 (in this example, U01) in the desired ride-sharing information 600 received from a ride-sharing wisher. The list 1100 of results illustrated in FIG. 11 may be created by, for example, the control unit 200 in the ride-sharing requesting apparatus 103 in S803 and may be stored in the storage unit 210. Alternatively, in another embodiment, the list 1100 of results illustrated in FIG. 11 may not be created by the control unit 200 in the ride-sharing requesting apparatus 103 in S803. In the example in FIG. 11, the ride-sharing goodness-of-fit 1103 is calculated for a case in which the reference cost Cb is 1,000 yen.

Next, in S804, the control unit 200 in the ride-sharing requesting apparatus 103 may take the total of values of ride-sharing goodness-of-fit 1103, which has been calculated in, for example, in S803, for each destination of each ride-sharing offering candidate to calculate a ride-sharing offering candidate-specific ride-sharing goodness-of-fit 1203. Then, ride-sharing offering candidates for which the ride-sharing offering candidate-specific ride-sharing goodness-of-fit 1203 is equal to greater than, for example, a prescribed threshold may be extracted as ride-sharing offering candidates corresponding to the desired ride-sharing information 600 to create ride-sharing offering candidate information 1200.

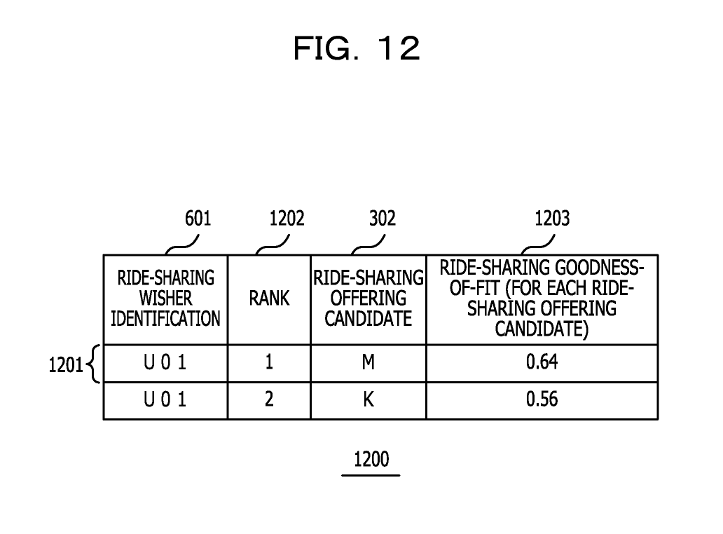

FIG. 12 illustrates the ride-sharing offering candidate information 1200. The ride-sharing offering candidate information 1200 includes ride-sharing suitable person information 1201. In the ride-sharing suitable person information 1201, the ride-sharing offering candidate-specific ride-sharing goodness-of-fit 1203 is registered in the S804 together with, for example, the ride-sharing offering candidate 302 for which the ride-sharing offering candidate-specific ride-sharing goodness-of-fit 1203 is equal to greater than a prescribed threshold and the ride-sharing wisher identification 601. In the example in FIG. 12, ranks 1202 are registered sequentially from the highest ride-sharing offering candidate-specific ride-sharing goodness-of-fit 1203. After the ride-sharing offering candidate information 1200 as described above has been created, this operation flow is terminated, causing the flow to proceed to S505, for example.

In S505, the control unit 200 in the ride-sharing requesting apparatus 103 sends a notification of the created ride-sharing offering candidate information 1200 to the ride-sharing wisher terminal 102 and accepts selected ride-sharing suitable person information 1201 from the ride-sharing wisher terminal 102, for example. In S506, the control unit 200 in the ride-sharing requesting apparatus 103 sends a notification of a ride-sharing request to the ride-sharing offering candidate terminal 101 of the ride-sharing offering candidate 302 indicated in the selected ride-sharing suitable person information 1201. The ride-sharing request may be, for example, the desired ride-sharing information 600. Next, in S507, the control unit 200 in the ride-sharing requesting apparatus 103 receives a reply for the ride-sharing request from the ride-sharing offering candidate terminal 101 and decides whether the ride-sharing request has been accepted by the ride-sharing offering candidate terminal 101. If the ride-sharing request has not been accepted by the ride-sharing offering candidate terminal 101 (the result in S507 is No), the flow proceeds to S512. In S512, the control unit 200 in the ride-sharing requesting apparatus 103 inquires the ride-sharing wisher terminal 102 whether it will obtain the latest vehicle's parking state and will update the vehicle parking state information 700, and receives a reply for the inquiry. If the control unit 200 receives, from the ride-sharing wisher terminal 102, a reply indicating that the vehicle parking state information 700 will be updated (the result in S512 is Yes), the flow proceeds to S502. If the control unit 200 receives, from the ride-sharing offering candidate terminal 101, a reply indicating that the latest vehicle's parking state will not be obtained (the result in S512 is No), the flow returns to S505.

If, in S507, a ride-sharing request has been accepted by the ride-sharing offering candidate terminal 101 (the result in S507 is Yes), the flow proceeds to S508. In S508, the control unit 200 in the ride-sharing requesting apparatus 103 decides whether an acceptance condition is included in the reply returned from the ride-sharing offering candidate terminal 101 for the accepted request. If no acceptance condition is included (the result in S508 is No), the flow proceeds to S509. If an acceptance condition is included (the result in S508 is Yes), the flow proceeds to S511. In S511, the control unit 200 in the ride-sharing requesting apparatus 103 sends a notification of the received acceptance condition to the ride-sharing wisher terminal 102 and receives a reply as to whether the acceptance condition is accepted. If, in S511, the control unit 200 receives a reply indicating that the acceptance condition is not accepted (the result in S511 is No) from the ride-sharing wisher terminal 102, the flow proceeds to S512. If, in S511, the control unit 200 receives a reply indicating that the acceptance condition is accepted (the result in S511 is Yes) from the ride-sharing wisher terminal 102, the flow proceeds to S509.

In S509, the control unit 200 in the ride-sharing requesting apparatus 103 notifies the ride-sharing offering candidate terminal 101 and ride-sharing wisher terminal 102 that ride sharing has been established. In S510, the control unit 200 in the ride-sharing requesting apparatus 103 decides whether to continue the processing. If the control unit 200 decides to continue the processing (the result in S510 is Yes), the flow returns to S501. If the control unit 200 decides not to continue the processing (the result in S510 is No), the flow is terminated. In an embodiment, this decision may be made according to whether the manager of the ride-sharing requesting apparatus 103 has entered an input signal into the ride-sharing requesting apparatus 103 to stop the ride-sharing requesting processing. If the manager of the ride-sharing requesting apparatus 103 has entered an input signal into the ride-sharing requesting apparatus 103 to stop the ride-sharing requesting processing, this operation flow may be terminated by deciding that the processing will not be continued.

If, for example, a reply indicating that the ride-sharing request is not accepted is received in S507 above, the ride-sharing offering candidate who has sent the reply may be deleted from the ride-sharing offering candidate information 1200 created in S504 before subsequent processing is carried out. Similarly, if a reply indicating that the acceptance condition is not accepted is received in S511, the ride-sharing offering candidate who has proposed the acceptance condition may be deleted from the ride-sharing offering candidate information 1200 created in S504 before subsequent processing is carried out. Furthermore, if the control unit 200 in the ride-sharing requesting apparatus 103 receives, from the ride-sharing wisher terminal 102, information indicating that a ride-sharing request according to the desired ride-sharing information 600 is cancelled, the control unit 200 may stop the ride-sharing requesting processing.

In the processing in S501 in the operation flow in FIG. 5 described above, the control unit 200 in the ride-sharing requesting apparatus 103 functions as, for example, the receiver 201. In the processing in S502 to S511, the control unit 200 in the ride-sharing requesting apparatus 103 functions as, for example, the transmitter 202. In the processing in S801 to S804 in the operation flow in FIG. 8, the control unit 200 in the ride-sharing requesting apparatus 103 functions as, for example, the transmitter 202.

According to the ride-sharing requesting processing in FIG. 5 described above, a next destination and a departure time in a departure to the next destination are inferred from, for example, the current parking place and the previous travel paths of the vehicle of a ride-sharing offering candidate, the previous travel paths being included in travel history information obtained from the vehicle. Then, the detour cost 1101 and time goodness-of-fit 1102, for example, are obtained according to the amount of change in elapsed time or travelled distance that will occur due to a switchover from a travel path between the current parking place and the inferred next destination to a travel path that passes through the ride place and drop-off place in the desired ride-sharing information 600. According to the obtained detour cost 1101 and time goodness-of-fit 1102, the ride-sharing offering candidate-specific ride-sharing goodness-of-fit 1203 is further obtained. According to the ride-sharing offering candidate-specific ride-sharing goodness-of-fit 1203, ride-sharing offering candidates suitable to a ride-sharing request are extracted. A ride-sharing request is then made for a ride-sharing offering candidate selected by the ride-sharing wisher from the extracted ride-sharing offering candidates. Therefore, the ride-sharing offering candidate can offer ride sharing without, for example, explicitly notifying, in advance, the ride-sharing requesting apparatus 103 of conditions under which the ride-sharing offering candidate can offer ride sharing. A departure time and destination of the parked vehicle of the ride-sharing offering candidate can also be inferred from the previous travels paths included in the travel history. Therefore, it is possible to select a ride-sharing offering candidate with which ride sharing is highly likely to be established for a ride-sharing desire from ride-sharing offering candidates including ride-sharing offering candidates who have yet to start the vehicle. Furthermore, according to the ride-sharing requesting processing in FIG. 5, a request to accept ride sharing is sent according to the amount of change in elapsed time or travelled distance that will occur due to a switchover from a previous travel path obtained from the vehicle's travel history to a travel path that passes through the desired ride place and desired drop-off place in ride sharing. Accordingly, a ride-sharing request can be sent in consideration of the amount of change due to the acceptance of ride sharing. It is also possible to increase the entire efficient from when the ride-sharing wisher has rode until the ride-sharing wisher gets off at a desired drop-off place and the shared vehicle arrives at its destination. Therefore, it is possible to suppress a burden on a person who offers a shared vehicle, suppress losses caused by the shared vehicle to accept ride sharing, and send a ride-sharing request in consideration of a burden on the shared vehicle offering person.

In description of the operation flow in FIG. 5, an example in which the ride-sharing wisher is first notified of the created ride-sharing offering candidate information 1200 in S505 has been taken. However, the embodiment is not limited to this. For example, in another embodiment, the control unit 200 in the ride-sharing requesting apparatus 103 may send a request to the ride-sharing offering candidate ranked at the top in the ride-sharing offering candidate information 1200 or a prescribed number of ride-sharing offering candidates counted from the ride-sharing offering candidate ranked at the top at S506 without executing S505.

In the example described above, the ride-sharing offering candidate-specific ride-sharing goodness-of-fit 1203 has been obtained according to the detour cost 1101 and time goodness-of-fit 1102 and the obtained ride-sharing offering candidate-specific ride-sharing goodness-of-fit 1203 has been used to determine the rank of each ride-sharing suitable person information 1201. However, the embodiment is not limited to this. For example, the rank of the ride-sharing suitable person information 1201 may be determined by using any one of the detour cost 1101 and time goodness-of-fit 1102.

In the embodiment described above, the travel pattern 301 and ride-sharing suitable person information 1201, for example, may further include, for example, information such as the gender and age bracket of the ride-sharing offering candidate 302. Similarly, the desired ride-sharing information 600 may further include, for example, information such as the gender and age bracket of the ride-sharing wisher 602. If a gender, an age bracket, and other information are included, the ride-sharing wisher and ride-sharing offering candidate can reference information on the gender and age bracket during the selection of the ride-sharing suitable person information 1201 in S505 and during the acceptance of a ride-sharing request in S506.

The operation flows in FIGS. 4, 5, and 8 described above, for example, are only examples. The embodiment is not limited to this. For example, if possible, these operation flows may be executed in a different processing order or other processing may be added. Alternatively, some processing may be omitted. For example, in another embodiment, the execution order of the processing in S801 and the processing in S802 in FIG. 8 may be changed.

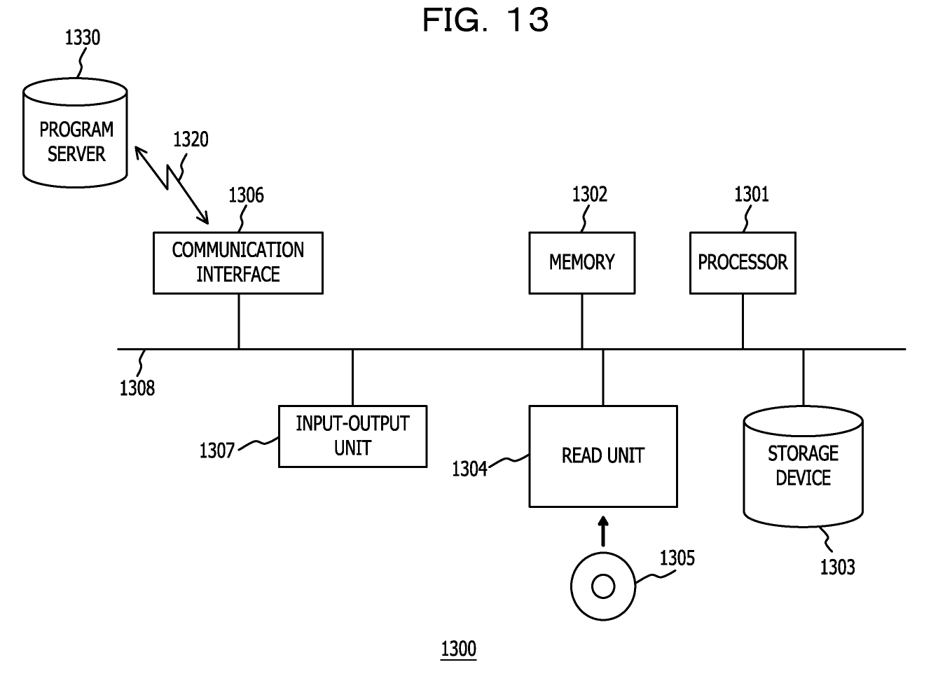

FIG. 13 illustrates the hardware structure of a computer 1300 in an embodiment that implements the ride-sharing offering candidate terminal 101, the ride-sharing wisher terminal 102, and the ride-sharing requesting apparatus 103. The computer 1300 in FIG. 13 includes, for example, a processor 1301, a memory 1302, a storage unit 1303, a read unit 1304, a communication interface 1306, and input-output unit 1307. The processor 1301, memory 1302, storage unit 1303, read unit 1304, communication interface 1306, and input-output unit 1307 are mutually coupled through, for example, a bus 1308.

The processor 1301 provides part or all of the functional parts described above by using the memory 1302 to execute, for example, a program in which procedures of the operation flows described above are coded. The control unit 200 in the ride-sharing requesting apparatus 103 is, for example, the processor 1301. The storage unit 210 includes, for example, the memory 1302, the storage unit 1303, and a removable storage medium 1305. The processor 1301 may function as, for example, the receiver 201 and transmitter 202 by reading out the program 220 from the storage unit 1303. The storage unit 1303 may store, for example, the program 220, the vehicle travel pattern information 300, and other information.

For example, the processor 1301 in the ride-sharing offering candidate terminal 101 may receive the desired ride-sharing information 600 from the ride-sharing requesting apparatus 103 through the communication interface 1306 and may display the desired ride-sharing information 600 on a display screen of the input-output unit 1307 such as a display unit. The processor 1301 in the ride-sharing offering candidate terminal 101 may accept a reply from a ride-sharing offering candidate through the input-output unit 1307 in response to the desired ride-sharing information 600 and may notify the ride-sharing requesting apparatus 103 of the reply. The processor 1301 in the ride-sharing offering candidate terminal 101 may also receive, for example, a notification of a result as to whether ride sharing has been established from the ride-sharing requesting apparatus 103 and may notify the ride-sharing offering candidate of the received result by displaying it on a display screen of the input-output unit 1307.

The processor 1301 in the ride-sharing wisher terminal 102 may create the desired ride-sharing information 600 from desired ride sharing conditions received from a ride-sharing offering candidate through the input-output unit 1307 and may notify the ride-sharing requesting apparatus 103 of the created desired ride-sharing information 600 through the communication interface 1306. The processor 1301 in the ride-sharing wisher terminal 102 may receive the ride-sharing offering candidate information 1200 from the ride-sharing requesting apparatus 103 as a reply for the desired ride-sharing information 600 of which the processor 1301 in the ride-sharing wisher terminal 102 has notified the ride-sharing requesting apparatus 103. The processor 1301 in the ride-sharing wisher terminal 102 may then notify the ride-sharing offering candidate of the received ride-sharing offering candidate information 1200 by, for example, displaying it on a display screen of the input-output unit 1307 such as a display unit. The processor 1301 in the ride-sharing wisher terminal 102 may also accept a selection about the proposed ride-sharing offering candidate information 1200, an additional acceptance condition, and other inputs through the input-output unit 1307, and may notify of the ride-sharing requesting apparatus 103. The processor 1301 in the ride-sharing wisher terminal 102 may also receive a result as to whether ride sharing has been established from the ride-sharing requesting apparatus 103 and may notify the ride-sharing wisher of the received result by displaying it on a display screen of the input-output unit 1307.

The memory 1302, which is, for example, a semiconductor memory, includes a random-access memory (RAM) area and a read-only memory (ROM) area. The storage unit 1303 is, for example, a hard disk drive, a semiconductor memory such as a flash memory, or an external storage unit.

The read unit 1304 accesses the removable storage medium 1305 in response to a command from the processor 1301. The removable storage medium 1305 is implemented by, for example, a semiconductor device such as a universal serial bus (USB) memory or a secure digital (SD) memory card, a medium such as a magnetic disk, to which information is magnetically input and from which it is magnetically output, a medium such as a compact disk-ROM (CD-ROM) or digital versatile disk (DVD), to which information is optically input and from which it is optically output.

The communication interface 1306 may be, for example, a wireless local area network (LAN) communication unit, an infrared communication unit, or another communication unit. The communication interface 1306 may transmit and receive data through a network 1320 in response to, for example, a command from the processor 1301. The input-output unit 1307 may be, for example, input keys that accept a command from the user, a touch panel, or another input device. Alternatively, the input-output unit 1307 may be, for example, a display unit such as a display or an output unit such as a speaker or another audio unit.

Programs in an embodiment are provided to the ride-sharing offering candidate terminal 101, ride-sharing wisher terminal 102, and ride-sharing requesting apparatus 103 in, for example, forms below.

(1) Installed in the storage unit 1303 in advance

(2) Provided from the removable storage medium 1305

(3) Provided from a server 1330 such as a program server

It is understood by a person having ordinary skill in the art that some embodiments including the embodiments described above include various variations and alternate forms of the embodiments described above. When various embodiments are embodied, constituent elements may be modified, for example. In the practice of various embodiments, a plurality of constituent element disclosed in embodiments described above may be appropriately combined. Furthermore, in the practice of various embodiments, some of all constituent elements indicated in embodiments may be deleted or replaced or some constituent element may be added to the constituent elements indicated in embodiments.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method comprising:
accepting information on a desired ride place in ride sharing and information on a desired drop-off place in the ride sharing;
identifying an amount of change in at least one of travel time and travel distance in case that a past travel path of a candidate vehicle for the ride sharing is changed to a travel path that passes through the desired ride place and the desired drop-off place; and
sending a request for the ride sharing to a terminal corresponding to the candidate vehicle in accordance with the identified amount of change.

2. The method of claim 1, further comprising:
accepting information on desired ride time in the ride sharing; and
selecting, from a plurality of past travel paths of the candidate vehicle, a candidate travel path that has higher probability that the candidate vehicle runs at the desired ride time or in a time zone including the desired ride time than that of another candidate travel path of the plurality of past travel paths, the candidate travel path being selected as the past travel path.

3. The method of claim 2, further comprising:
estimating, for each of the plurality of past travel paths, each probability that the candidate vehicle runs at the desired ride time or in the time zone including the desired ride time.

4. The method of claim 2, further comprising:
estimating probability distribution of arrival time at which the candidate vehicle arrives at the desired ride place in accordance with probability distribution of a departure time at a travel start place on the past travel path and time taken to travel on a path from the travel start place to the desired ride place; and
estimating the probability that the candidate vehicle runs at the desired ride time or in the time zone including the desired ride time, in accordance with the estimated probability distribution of the arrival time.

5. An apparatus comprising:
a memory; and
a processor coupled to the memory and configured to
accept information on a desired ride place in ride sharing and information on a desired drop-off place in the ride sharing;
identify an amount of change in at least one of travel time and travel distance in case that a past travel path of a candidate vehicle for the ride sharing is changed to a travel path that passes through the desired ride place and the desired drop-off place; and
send a request for the ride sharing to a terminal corresponding to the candidate vehicle in accordance with the identified amount of change.

6. A non-transitory computer-readable medium including a program, which when executed by a computer, causes the computer to execute a process, the process comprising:
accepting information on a desired ride place in ride sharing and information on a desired drop-off place in the ride sharing;
identifying an amount of change in at least one of travel time and travel distance in case that a past travel path of a candidate vehicle for the ride sharing is changed to a travel path that passes through the desired ride place and the desired drop-off place; and
sending a request for the ride sharing to a terminal corresponding to the candidate vehicle in accordance with the identified amount of change.
